(19) United States
(12) Patent Application Publication
(10) Pub. No.: US 2007/0130534 A1
(43) Pub. Date: Jun. 7, 2007

(54) Graphic user interface with multi-divisional window

(75) Inventors: Yu-Shen Liu, Taichung (TW); Hsiang-Hua Chao, Taipei (TW)

Correspondence Address: BIRCH STEWART KOLASCH & BIRCH, PO BOX 747, FALLS CHURCH, VA, 22040-0747, US

(73) Assignee: C-Media Electronics Inc.

(21) Appl. No.: 11/292,084

(22) Filed: Dec. 2, 2005

(51) Int. Cl. G06F 9/00

(52) U.S. Cl. 715/770

(57) ABSTRACT

The present invention discloses a graphic user interface (GUI) of a computer software. When users perform the actions of copying, pasting and cutting, the users need to open several windows to perform these actions. The results in that users are persecuted by too many windows. Accordingly, the present invention provides a graphic user interface. The graphic user interface provides two or more divisional windows. The divisional windows are comfortable for user to perform file copying, cutting and pasting.

### FIELD OF THE INVENTION

The present invention is related to a graphic user interface, especially to a graphic user interface applied to a card reader and method for the same.

### BACKGROUND OF THE INVENTION

The common graphic user interface (GUI) performs the actions of copying, pasting and cutting of data files, the users need to open several transition windows to perform these actions. In performing the above graphic user interface (GUI), users are easily to persecute owing to opening too many transition windows such that data files copying, cutting and pasting result in data wrong transmission during the data transferring process.

Nowadays, most of personal computers may connect external hardware devices, such as memory cards and perform the functions of copying, pasting and cutting of data files by means of graphic user interface (GUI) provided by Microsoft windows operating platform. Under the Microsoft windows operating platform, copying, pasting and cutting of data files (for example: data files transferring among the card readers or data files transferring between the card and hard discs) for multi-hardware are need to perform by means of opening various windows, i.e. transition windows, with the corresponding hardware devices. In performing the above graphic user interface (GUI), users are easily to produce over-lapping issue of the transition windows owing to opening too many transition windows such that users need to use a mouse for moving every transition window in-conveniently.

Thus, the main objective is become to overcome above prior art issue, for example during the usage of the above graphic user interface (GUT) by users, to reduce inconvenience for use and avoid the problem of data wrong transmission during the data transferring process of data files copying, cutting and pasting.

### SUMMARY OF THE INVENTION

One aspect of the invention is to provide a graphic user interface (GUI) of a computer system used to display synchronously the content of the computer system and the content of pluralities of electric devices on one monitor, and the GUI being displayed in a main window type, the GUI comprising: a visual icon displayed on the monitor for indicating an action of an instruction; a button list displayed on the monitor for providing buttons with functions, the visual icon and the button list located on the upper region of the main window; a sub window of directory structure displayed on the monitor displaying the directories of a hard disk associated with the computer system, wherein the sub window of directory structure is displayed with a multi-level tree structure, and being located on the one of left/right region of the main window and below the visual icon and the button list; a sub window of file folder displayed on the monitor for displaying files and folders within one directory of the sub window of a directory structure, wherein the sub window of file folder, near the sub window of directory structure, and being located on one of the right/left region of the main window and below the visual icon and the button list; and one or more sub windows of electric devices displayed on the monitor for displaying files and folders within the electric devices, wherein the sub windows of electric devices, adjacent to the sub window of directory structure, and being located on the bottom region of the sub window of file folder.
1. The sub windows of electric devices is shown in a stack method.
2. The button list comprises: a encrypt button, a decrypt button, a low-level format button, a print button, a driver program button, and a private hardisk (HD) button; when clicking one of a buttons in the button list, the computer system will execute the function defined by the button.
3. The button list comprises a private HD button, wherein the private HD button having the function of locking and un-locking a hard disk of the computer system.
4. A method of processing a graphic user interface (GUI) of a computer system, the method comprising:
   providing a cursor for clicking an object display on a monitor;
   providing a visual icon and clicking the visual icon of a memory card by means of the cursor;
   generating a sub window for displaying the content of the memory card;
   generating a sub window of directory structure;
   generating a sub window of file folder, wherein the sub window of file folder displays the files and folders of the ordering directory; and
   performing the actions of copying, pasting and cutting by means of the cursor.

### BRIEF DESCRIPTION OF THE DRAWINGS

FIG. 1 is a function diagram of computer system.

FIG. 2 is a user interface of the present invention.

FIG. 3 is a user interface of the present invention.

FIG. 4 is a flow chart gram of the present invention.

FIG. 5 is a flow chart gram of the present invention.

### DETAILED DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments. Besides, the present invention is not limited to any embodiment but to the appending claims and their equivalents.

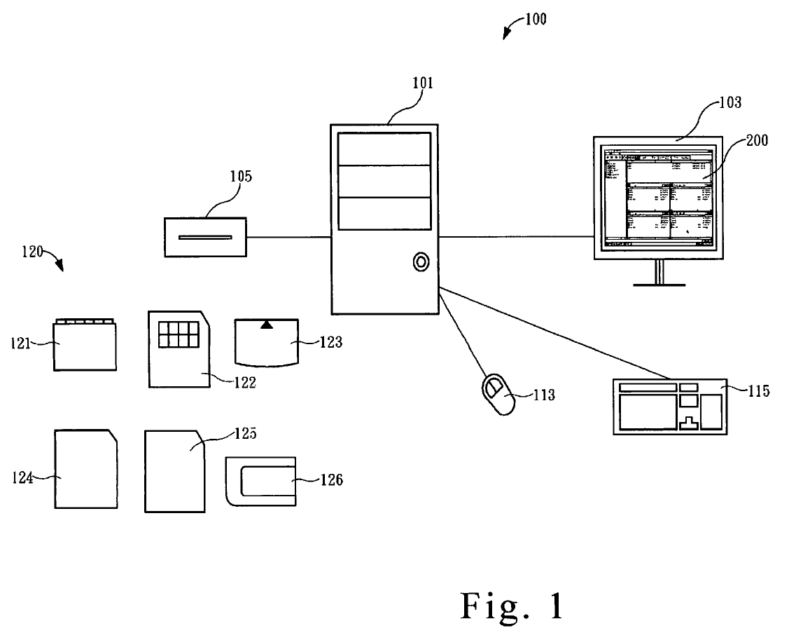

FIG. 1 shows a computer system 100 comprising plural kinds of memory cards 120, a monitor 103, a personal computer (PC) 101 and a graphic user interface (GUI) 200. The above-mentioned PC 101 s connected between a card reader 105 and the monitor 103, wherein the card reader 105 may read various memory card synchronously, for example, a compact flash (CF) card 121, a smart media (SM) card 122, XD card 123, secure digital (SD) card 124, a multi media card (MCC) 125, and memory stick (MS) card 126. It is appreciated that a micro drive and MS pro device not drawn is still suitable to the present invention. Besides, the present invention is not limited to the memory card and micro memory device stated above. Any kind of micro memory device associated with the computer system of the present invention suitably may be accepted.

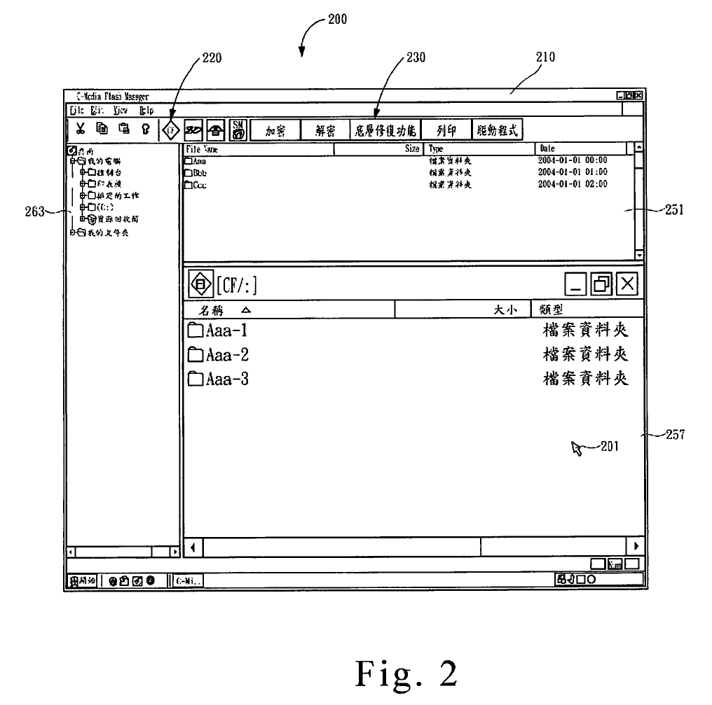

Additionally, FIG. 2 shows mentioned GUI 200 comprising a main window 210, a cursor 201 and a sub window of the first memory card 257. The main window 210 stated above displaying a visual icon 220, a button list 230, a sub window of directory structure 263 and a sub window of file folder 251. The GUI 200 is displayed on the monitor 103. And the visual icon 220 and button list 230 is shown on the upper region of the monitor 103. The sub window of directory structure 263 is displayed on the left region of the monitor 103 and below the visual icon 220 and button list 230. Moreover, the sub window of the first memory card 257 is displayed on the right region of the monitor and below the sub window of file folder 251. Users may click the visual icon 220 or button list 230 by means of the cursor 201 for executing the function of the icon or the button. For example, when clicking the icon of the first memory card 121 (i.e. CF card) within plural kinds of memory cards 120, the data content of the first memory card 121 will be displayed on the sub window of the first memory card 257. As the illustration of the FIG. 2, the monitor displays three windows, one is the sub window of directory structure 263, another is the sub window of file folder 251, the other is the sub window of the first memory card 257. The sub window of directory structure 263 displays the directory of the hard disk associated with the PC 101 and the sub window of directory structure 263 displays in a multi-level tree structure. The sub window of file folder 251 displays the folder of the hard disk ordered via the cursor 201. And the sub window of the first memory card 257 displays data directory of the first memory card 121. Accordingly, users may instruct the PC to perform the actions of copying, pasting and cutting the files between the first memory card 121 and the sub window of file folder 251 via cursor 201 and the three windows stated above.

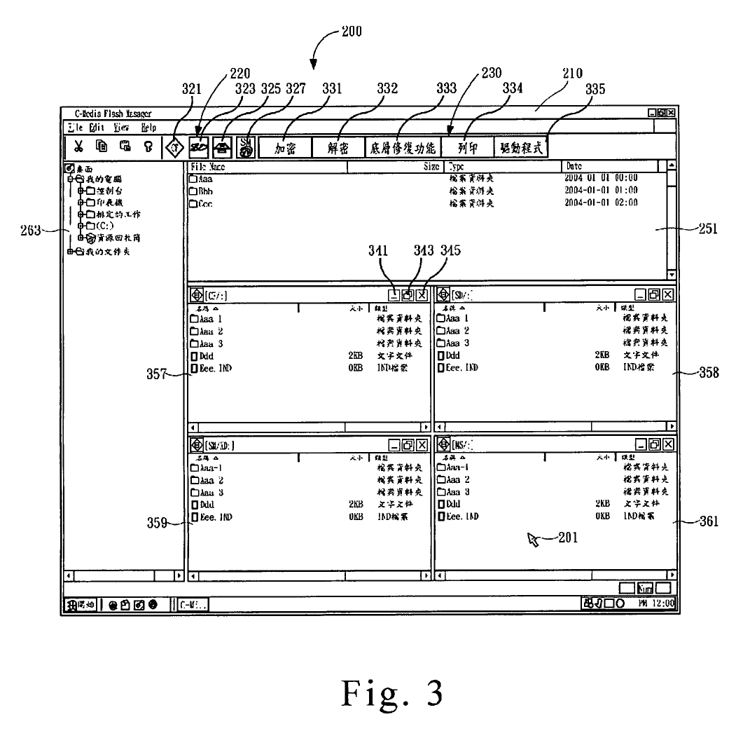

The sub window of the first memory card 257 of the GUI 200 may be divided into two or more sub windows. The content of the specific memory card may be shown on the specific window, respectively. As the illustration of FIG. 3, the CF icon 321 indicates CF card or micro disk 121, SD icon 323 indicates SD card 124, MS icon 325 indicates MS card 126 and SM/XD icon 327 indicate SM card 122 and XD card 123. When the five kinds of memory card are plugged in the corresponding card reader 105, a user may click or order the icon indicated the memory card via the cursor 201. The sub window of the memory card can be divided into four sub windows via the CF icon, SD icon, MS icon and SM/XD icon. The four sub windows may indicate the sub window of the first memory card 357 (i.e. the sub window of CF card or micro disk 121), the sub window of the second memory card 358 (i.e. the sub window of SD card 124 or MMC 125), the sub window of the third memory card 359 (i.e. the sub window of SM/XD card 122/123), the sub window of the fourth memory card 361 (i.e. the sub window of MS card or MS pro card 124). The user may instruct the PC to perform the actions of copying, pasting and cutting the files of the CF card or micro disk 121, SD card 124, MMC 125, AM/XD card 122/123, MS card or MS pro card 124 via the cursor 201, the sub window of file folder 251, the sub window of directory structure 263 and the four windows. The user may also interchange the file of the PC 101 and the memory card via GUI 200 and perform the actions of copying, pasting and cutting the files between the different kind of memory card i.e. copying, pasting and cutting the files of the CF card to the XD card for the data exchanging.

However, the sub window of the first memory card 257 is not limited to be divided into two dividing sub window for providing copying, pasting and cutting the files between the different kind of sub windows. The sub window of the first memory card 257 may have a_icon 341 for the hiding of the window, a □ icon 343 for the opening of the window, and a X icon 345 for the closing of the window. In other words, a user may control one or more sub windows of memory cards at the same region via a_icon 341, a □ icon 343, and a X icon 345 for stacking the different sub windows of the memory card instead of dividing in two or more sub windows. Thus, the user may perform the actions of copying, pasting and cutting the files according to his custom.

Otherwise, the main window 210 further contains a encrypt button 331, a decrypt button 332, a low-level format button 333, a print button 334, and a driver program button 335. The user may execute the tool function by means of these buttons stated above. For example, an encrypt button 331 provides the encrypting function for encrypting the file of the memory card. The user may also format the memory card via low-level format button 333 or update the drive program via the drive program button 335. Of course, the user may execute file printing function via print button 334.

Besides, another embodiment of the present invention further comprises a private HD button (does not display in the illustrations of the present invention) having the function of locking the reading action of the memory card within the card reader for protecting the data of the memory card. When executing this function of locking, any user may not read the data of the memory card. For unlocking, the user may enter a specific password.

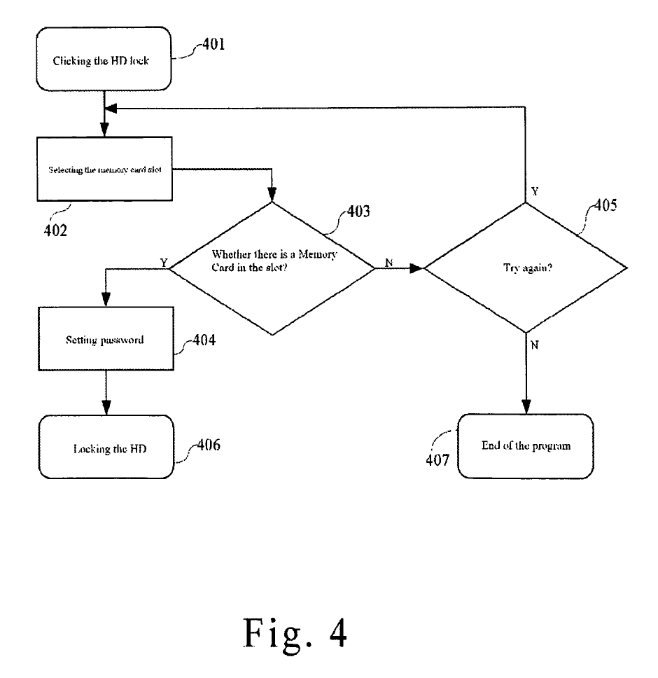

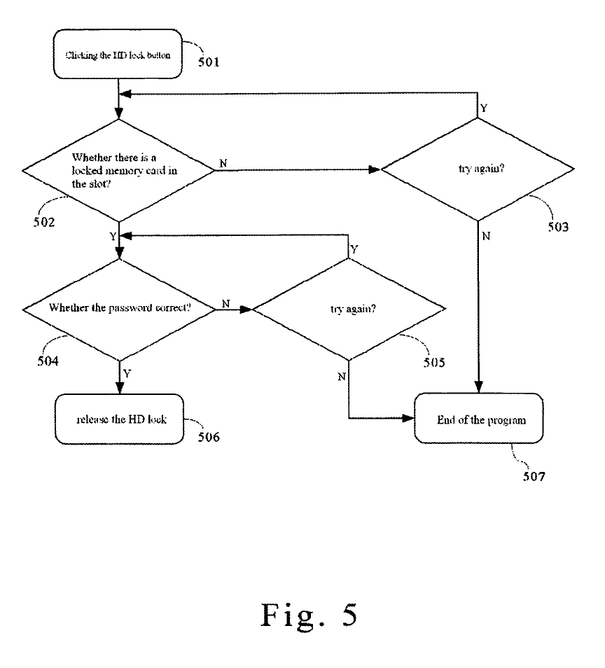

The operation is illustrated in FIGS. 4 and 5, the bottom is clicked to active the private HD protection function 401. The next step is to appoint the memory card slot associated with the private HD 402. The way to select the memory card slot is by means of ejection window to provide the associated card slot for selection. After the selection, the system will check whether the selected card slot is available or not 403. If negative, the system will query whether the user tries again or not, 405. The query step is similar to the step 402. If the user does not try again, the program will be end in step 407. If the user chose the desired memory card slot, the system will ask the user to input the password, 404. The step of request for the password is similar with the step of 402, 405 by using the ejection window. After the password is input, the protection sequence is done. The system HD cannot be fetched by anyone.

To release the protection, the operation is shown in FIG. 5, the user clicks the private HD icon 501, the system will check where the memory card is inserted in the pre-selected memory card slot in 502. If not, the system will ask to try again 503. If the user does not want to try, the system will end of the program 507. Otherwise, the process will back to step 502. After the confirmation in 502 is positive, the password will be asked, and the system will determine whether the input password is identical to the pre-provided password or not in 504. If not, the system will ask the user try again in 505. If the user does not want to try, the system will end of the program 507. Otherwise the next step backs to step 504. When the password is identical to the previously input password, the protection status will be released 506. In the step 503, 504 and 505, the way of query for password is processed by ejection (or “pop-up”) window.

The benefits of the present invention: the system may provide multi-divided window or overlap window to process the data processing between the PC 101 and first memory card 102 via the user interface 200 without opening extra window to waste the computer resources or confusing the user due to too many opened window are displayed on the monitor at the same time. The mistakes of copying error, cutting error will be reduced by the present invention. The multi-window will display a lot of content of a lot of files by displaying the contents at the same time or synchronicity.

Although specific embodiments have been illustrated and described, it will be obvious to those skilled in the art that various modifications may be made without departing from what is intended to be limited solely by the appended claims.

We claim:

1. A graphic user interface (GUI) of a computer system used to display synchronously the content of said computer system and the content of pluralities of electric devices on one monitor, and the GUT being displayed in a main window type, the GUT comprising:
a visual icon displayed on said monitor for indicating an action of an instruction;
a button list displayed on said monitor for providing buttons with functions, said visual icon and said button list located on the upper region of said main window;
a sub window of directory structure displayed on said monitor displaying the directories of a hard disk associated with said computer system, wherein said sub window of directory structure is displayed with a multi-level tree structure, and being located on the one of left/right region of said main window and below said visual icon and said button list;
a sub window of file folder displayed on said monitor for displaying files and folders within one directory of said sub window of a directory structure, wherein said sub window of file folder, near said sub window of directory structure, and being located on one of the right/left region of said main window and below said visual icon and said button list; and
one or more sub windows of electric devices displayed on said monitor for displaying files and folders within said electric devices, wherein said sub windows of electric devices, adjacent to said sub window of directory structure, and being located on the bottom region of said sub window of file folder.

2. The GUI according to claim 1, wherein said sub windows of electric devices is shown in a stack method.

3. The GUT according to claim 1, wherein said visual icon is clicked by a mouse, a keyboard, or both of them.

4. The GUI according to claim 1, wherein said visual icon comprising: a compact flash(CF) icon, a secure digital(SD) icon, a smart media(SM)/XD icon and memory stick(MS) icon; when clicking one of said visual icons, the content of said electric device associated with said icon will be displayed in said sub window of electric device.

5. The GUI according to claim 1, wherein said button list comprising: a encrypt button, a decrypt button, a low-level format button, a print button, a driver program button, and a private hardisk (HD) button; when clicking one of a buttons in said button list, said computer system will execute the function defined by said button.

6. The GUI according to claim 1, wherein said electric device is a memory card or a card reader of a micro drive.

7. The GUI according to claim 6, wherein said card reader supports MS card or memory stick pro (MS pro) card.

8. The GUI according to claim 6, wherein said card reader supports multi-media card (MCC).

9. The GUI according to claim 6, wherein said card reader supports SD card.

10. The GUI according to claim 6, wherein said card reader supports CF card or a micro drive.

11. The GUI according to claim 6, wherein said card reader supports SM card.

12. The GUI according to claim 6, wherein said card reader supports XD card.

13. The GUI according to claim 6, when a memory card is plugged into said card reader, one or more sub windows of said electric devices will be switched for displaying the content of said memory card.

14. The GUI according to claim 6, wherein said button list comprises a private HD button, wherein said private HD button having the function of locking and un-locking a hard disk of said computer system.

15. A graphic user interface (GUI) displayed in a main window type, the GUI comprising:
a button list displayed on said monitor for providing buttons with functions, said visual icon and said button list located on the upper region of said main window;
a sub window of directory structure displayed on said monitor displaying the directories of a hard disk associated with said computer system, wherein said sub window of directory structure is displayed with a multi-level tree structure, and being located on the one of left/right region of said main window and below said visual icon and said button list;
a sub window of file folder displayed on said monitor for displaying files and folders within one directory of said sub window of a directory structure, wherein said sub window of file folder, near said sub window of directory structure, and being located on one of the right/left region of said main window and below said visual icon and said button list; and
a plurality of sub windows of card readers displayed on said monitor for displaying files and folders of memory cards within said card readers, wherein said sub windows of card readers, adjacent to said sub window of directory structure, located on the bottom region of said sub window of file folder.

16. The GUI according to claim 15, wherein said sub windows of electric devices is shown in a stack method.

17. The GUT according to claim 15, wherein said visual icon is clicked by a mouse, a keyboard, or both of them.

18. The GUI according to claim 17, wherein said visual icon comprising: a compact flash(CF) icon, a secure digital(SD) icon, a smart media(SM)/XD icon and memory stick(MS) icon; when clicking one of said visual icons, the content of the electric device associated with said icon will be displayed in said sub window of card readers.

19. The GUI according to claim 17, wherein said button list comprising: a encrypt button, a decrypt button, a low-level format button, a print button, a driver program button, and a private hardisk(HD) button; when clicking one button of said button list, said computer system will execute the function defined by said button.

20. A method of processing a graphic user interface (GUI) of a computer system, the method comprising:
providing a cursor for clicking an object display on a monitor;
providing a visual icon and clicking said visual icon of a memory card by means of said cursor;
generating a sub window for displaying the content of said memory card;
generating a sub window of directory structure;
generating a sub window of file folder, wherein said sub window of file folder displays the files and folders of the ordering directory; and
performing the actions of copying, pasting and cutting by means of said cursor.
